(19) United States
(12) Patent Application Publication
(10) Pub. No.: US 2008/0314682 A1
(43) Pub. Date: Dec. 25, 2008

(54) Ladder stabilizing brace

(76) Inventors: Jeff Cogswell, Coral Springs, FL (US); Ian White, Coral Springs, FL (US)

Correspondence Address: ROBERT M. DOWNEY, P.A., 6751 N. FEDERAL HWY., SUITE 300, BOCA RATON, FL, 33487, US

(21) Appl. No.: 12/157,036

(22) Filed: Jun. 7, 2008

Related U.S. Application Data
(60) Provisional application No. 60/946,021, filed on Jun. 25, 2007.
(60) Provisional application No. 60/952,281, filed on Jul. 27, 2007.

(51) Int. Cl. E06C 7/46

(52) U.S. Cl. 182/108

(57) ABSTRACT

A ladder stabilizing brace is attachable to respective ladder stiles for laterally stabilizing the ladder from tipping. Each stabilizer includes a body channel affixable to one of the ladder stiles. A stabilizer base has a first end pivotally affixed to a bottom end of the body channel such that the stabilizer base pivots between a stowed position in vertical parallel registration with the body channel to a deployed position extending outwardly from said body channel. An adjustable center brace for locking the stabilizer base in its deployed position extends between an upper end of the body channel and a second end of the stabilizer base opposite from the first end.

### CROSS REFERENCE TO RELATED APPLICATIONS

This application claims the benefit of U.S. Provisional Patent Application Ser. No. 60/946,021, filed Jun. 25, 2007, and U.S. Provisional Patent Application Ser. No. 60/952,281, filed Jul. 27, 2007.

### BACKGROUND OF THE INVENTION

1. Field of the Invention

The present invention relates to ladders in general, and more particularly to safety devices for ladders.

2. Discussion of the Related Art

Ladders have become a useful tool to almost every individual in society and allow individuals to climb to heights unreachable by the unaided Individual ladders can range from small stepladders having 2-3 rungs allowing an individual to access that one item just out of reach to large extension ladders that can extend to 40 feet and more for scaling large walls, trees, and buildings. One or more ladders can be found in almost every household.

Unfortunately, the design and usage of a ladder also contributes to its inherent instability and danger. A ladder is typically constructed of two spaced apart vertical stiles with a plurality of regularly spaced rungs extending between the stiles. The bottom end of each stile also functions as the support foot for the ladder at its base. While the base of some ladders may be wider than the ladder top, the overall width of the ladder is relatively narrow when compared to its height. As the width to height ratio decreases (with increasing ladder height) the lateral stability of the ladder also decreases such that a minor lateral shift in the combined center of gravity of the ladder, including the user who is climbing the ladder, can result in an unwanted lateral shift of the ladder. As the user climbs the ladder the combined center of gravity also translates up the ladder, and consequently the danger from a minor lateral shift in the center of gravity increases proportionately as the center of gravity rises. In extreme cases, the unwanted lateral shift can and often does result in the ladder falling to the ground with the user suffering serious injuries as a result thereof. The U.S. Consumer Product Safety Commission (CPSC) reports that each year there are in excess of 150,000 emergency room-treated injuries in the U.S. relating to ladders. A significant portion of which are attributable to ladder falls.

A number of ladder aids have been developed to help prevent ladders from tipping. Some ladders include a very wide fixed base to help stabilize the ladder. Some extension ladders incorporate a wide fixed brace at the top to stabilize the ladder against a wall to prevent the ladder from twisting. Large fixed braces become inconvenient and cumbersome for storage and transportation. Other ladders incorporate tie-off devices at the top so that the top of the ladder can be secured to the structure against which it is supported. However, a tie-off system is difficult and sometimes impossible to use when the ladder is supported against a wall or the side of a building.

Thus what is desired is a ladder stabilization system that provides effective lateral stabilization for the ladder and is also stowable for ease of transportation and storage.

### SUMMARY OF THE INVENTION

The present invention is directed to a ladder stabilizer that satisfies the need for a stowable stabilizer for ease of transportation and storage. The ladder stabilizing brace is attachable to respective ladder stiles for laterally stabilizing the ladder from tipping. Each stabilizer includes a body channel affixable to one of the ladder stiles. A stabilizer base has a first end pivotally affixed to a bottom end of the body channel such that the stabilizer base pivots between a stowed position in vertical parallel registration with the body channel to a deployed position extending outwardly from said body channel. An adjustable center brace for locking the stabilizer base in its deployed position extends between an upper end of the body channel and a second end of the stabilizer base opposite from the first end.

Another aspect of the present invention is a ladder stabilizing brace attachable to a ladder stile for laterally stabilizing the ladder from tipping. The stabilizing brace includes a stabilizer base having a first end defining at least one aperture therethrough for pivotally affixed to a bottom of a ladder stile. When so attached the stabilizer base pivots between a stowed position in vertical parallel registration with the ladder stile to a deployed position extending outwardly from the ladder stile. An adjustable center brace has a first end defining an aperture therethrough for pivotal attachment to the ladder stile and a second end pivotally affixed to a second end of the stabilizer base opposite from said first end for locking the stabilizer base in its deployed position.

Yet another aspect of the present invention is a ladder of the type having a pair of laterally spaced stiles supporting a plurality of vertically spaced rungs. Each stile includes a hinge at a bottom outer surface thereof and an integral stabilizing brace pivotally affixed to each said hinge. Each stabilizing brace comprises a stabilizer base having a first end defining at least one aperture therethrough pivotally affixed to the hinge such that the stabilizer base pivots between a stowed position in vertical parallel registration with the ladder stile to a deployed position extending outwardly from the ladder stile. An adjustable center brace has a first end pivotally attached to the ladder stile and a second end pivotally affixed to a second end of the stabilizer base opposite from said first end for locking the stabilizer base in its deployed position.

These and other features, aspects, and advantages of the invention will be further understood and appreciated by those skilled in the art by reference to the following written specification, claims and appended drawings.

### BRIEF DESCRIPTION OF THE DRAWINGS

For a fuller understanding of the nature of the present invention, reference should be made to the following detailed description taken in conjunction with the accompanying drawings in which:

FIG. 1 is a perspective view of a stepladder to which is attached a stabilizer embodying the present invention wherein the stabilizer is deployed in a stabilizing mode;

FIG. 2 is a perspective view of the stabilizer of FIG. 1 wherein the stabilizer is in a stowed configuration;

FIG. 3 is an exploded perspective view of the stabilizer shown in FIG. 1;

FIG. 4 is an alternate embodiment of a ladder stabilizer wherein the stabilizer is part of the original ladder configuration

FIG. 5 is a perspective view of the stabilizer of FIG. 4 wherein the stabilizer is in a stowed configuration.

Like reference numerals refer to like parts throughout the several views of the drawings.

### DETAILED DESCRIPTION OF THE PREFERRED EMBODIMENTS

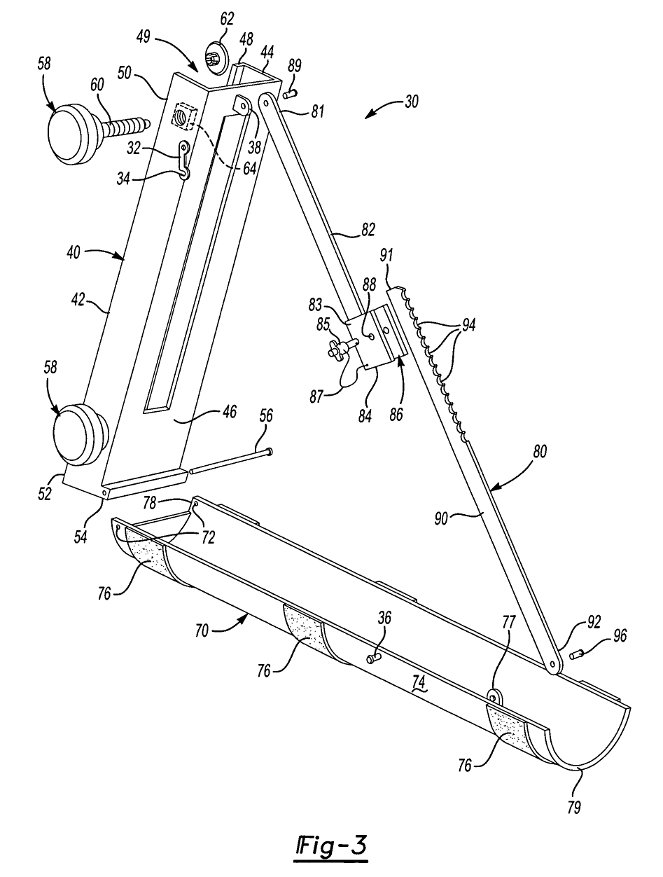

For purposes of description herein, the terms “upper”, “lower”, “left”, “rear”, “right”, “front”, “vertical”, “horizontal”, and derivatives thereof shall relate to the invention as oriented in FIG. 3. However, one will understand that the invention may assume various alternative orientations and step sequences, except where expressly specified to the contrary. While the present invention has been shown and described in accordance with preferred and practical embodiments thereof, one will also recognize that departures from the instant disclosure are fully contemplated within the spirit and scope of the invention. Hence, specific dimensions and other physical characteristics relating to the embodiments disclosed herein are not to be considered as limiting, unless the claims expressly state otherwise.

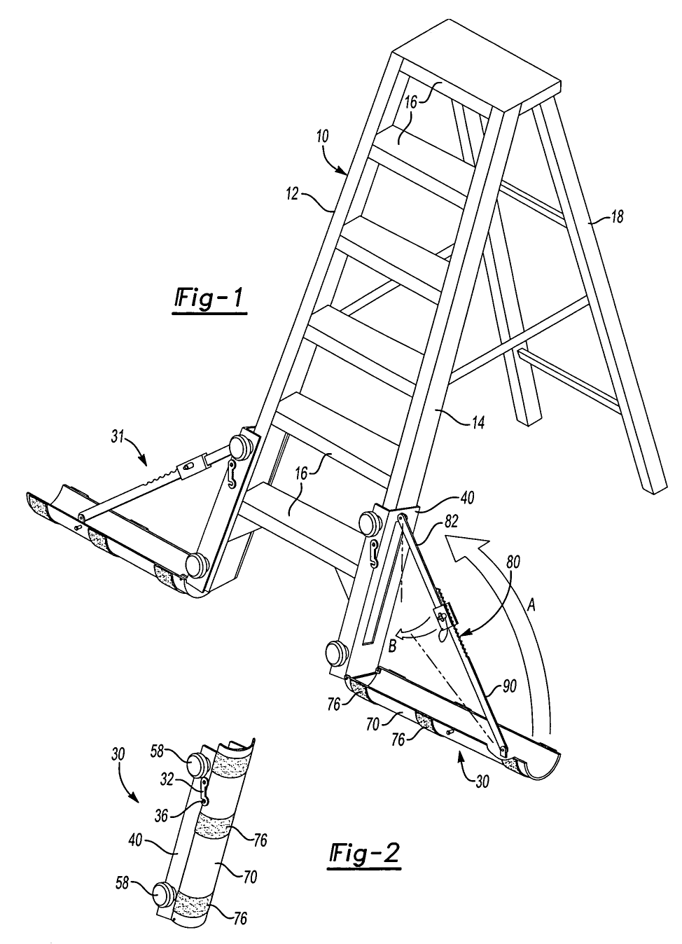

Turning to the drawings, FIG. 1 shows a stepladder 10 with a pair of ladder stabilizing braces 30, 31 affixed thereto which is one of the preferred embodiments of the present invention and illustrates its various components. Step ladder 10 is of the type having two substantially vertical laterally spaced apart stiles 12, 14 with a plurality of vertically spaced steps or rungs 16 extending between stiles 12 and 14. Stepladder 10 also includes a rear support 18 thereby permitting stepladder 10 to be free standing. Those practiced in the art will readily recognize that the embodiments and concepts described herein are also applicable to other fixed and extension ladders (not shown) not having a rear support and that require support from the structure or object against which the ladder is leaned.

Referring now to FIGS. 1-3, ladder 10 has a right ladder stabilization brace 30 affixed to a right stile 14 and a mirror image left ladder stabilization brace 31 affixed to a left stile 12. The description herein will refer to stabilization brace 30 with the understanding that stabilization brace 31 is identical but opposite. As most clearly seen in FIG. 3, ladder stabilization brace 30 has a channel body 40 which is formed as a rectangular channel having a front leg 42 and a rear leg 44 which are interconnected by an outer side web 46. Legs 42 and 44 and web 46 form a rectangular U-shaped channel defining a recess 49 in which is received right stile 14 of ladder 10. Rear leg 44 can also include a lip 48 extending from an edge opposite from and substantially parallel to web 46. Lip 48 functions to engage an inner edge of stile 14 to prevent channel body 40 from inadvertent slippage and disengagement once channel body 40 has been secured to stile 14. Front leg 42 can also include a threaded aperture 64 proximate to both a top end 50 and bottom end 52 of channel body 40. Threaded aperture 64 receives a threaded shaft 60 of tightening knob 58. A bearing pad 62 is rotatably affixed to an end of threaded shaft 60 for bearing against a front of stile 14. Bottom end 52 of channel body 42 also has a hinge 54 receiving hinge pin 56 therein.

A stabilizer base 70 is formed as a channel and most preferably as a semi-cylindrical channel wherein an outer cylindrical surface 74 is oriented downward and an axis of the cylinder extends from proximal end 78 to distal end 79. Outer surface 74 has affixed thereto a non-slip layer and in the most preferred embodiment non-slip layer is affixed as a plurality of regularly spaced non-slip strips 76. Non-slip strips 76 are typically made from a resilient material such as rubber or other similar non-slip material. A proximal end 78 of stabilizer base 70 defines apertures 72 therethrough for receiving hinge pin 56 and thus pivotally affixing stabilizer base 70 to channel body 40. Stabilizer base 70 can pivot from a deployed position as substantially shown in FIG. 3 to a stowed position as shown in FIG. 2 wherein stabilizer base 70 is pivoted up to be substantially in vertical parallel registration with channel body 40.

Channel body 40 can further include a latch 32 positioned near top end 50. Latch 32 defines a notch 34 at an end thereof. When stabilizer base 70 is in its stowed position latch 32 can be rotated about a pivot point such that notch 34 receivingly engages latch pin 36 extending from outer surface 74 of stabilizer base 70. Latch 32 when engaged on latch pin 36 maintains stabilizer base 70 in its stowed position to facilitate the transport and storage of the ladder without requiring the removal of stabilizer braces 30, 31 from ladder 10.

When stabilizer base 70 is in a deployed position, an adjustable brace 80 extends between the top end of channel body 40 and the distal end 79 of stabilizer base 70. Adjustable brace 80 has a first brace arm 82 that has a first end 81 pivotally affixed to ear 38 extending from channel body 40 with pin 89 such that first brace arm 82 pivots freely about pin 89. A sleeve 84 is affixed to a second end 83 of first brace arm 82. Sleeve 84 defines a sleeve opening 86 and a lateral aperture 88. A locking pin 85 is affixed to second end 83 with a lanyard 87. A second brace arm 90 has a second end 92 pivotally affixed to internal ear 77 within stabilizer base 70 with pin 96 such that second brace arm 90 pivots freely about pin 96. A first end 91 of second brace arm 90 has a plurality of regularly spaced recesses 94 along a top edge of second brace arm 90 and is slidingly received in sleeve 84 of first brace arm 82.

In use, ladder stabilizer brace 30 is affixed to right ladder stile 14 by loosening tightening knobs 58 to permit right ladder stile 14 to be received in recess 49 of channel body 40. Tightening knobs 58 are rotated so that bearing pads 62 engage the front of stile 14 and translate stile 14 against rear leg 44 of channel body 40 until stile 14 is compressingly clamped within channel body 40. Lip 48 prevents channel body 40 from being laterally disengaged from stile 14. Latch 32 is pivoted to disengage notch 34 from latch pin 36 on stabilizer base 70 thereby allowing stabilizer base 70 to pivot downward from channel body 40. First end 91 of second brace arm 90 is placed in sleeve opening 86 and stabilizer base 70 is pivoted to maximum contact with the surface on which ladder 10 is to be supported. Lock pin 85 is inserted in lateral aperture 88 of sleeve 84 and engages one of recesses 94 on second brace arm 90. Since the surface on which ladder 10 is being supported may not be level, the plurality of recesses 94 permit stabilizer base 70 to be angularly adjusted with respect to channel body 40 by lock pin 85 engaging different ones of recesses 94. Left stabilizer brace 31 is affixed to and adjusted relative to left stile 12 in a like manner. The semi-cylindrical form of stabilizer base 70 allows for positive contact of stabilizer base 70 with the surface on which ladder 10 is supported regardless of the angulation of stiles 12 and 14 from vertical.

Upon completion of use of ladder 10, stabilizer base 70 can be stowed by removing locking pin 56, disengaging second brace arm 90 from sleeve 84 allowing brace arms 82 and 90 to pivot downward (Arrow ‘B’ FIG. 3), pivoting stabilizer base upward (Arrow ‘A’ FIG. 3) against channel body 40, and re-engaging latch 32 on latch pin 36.

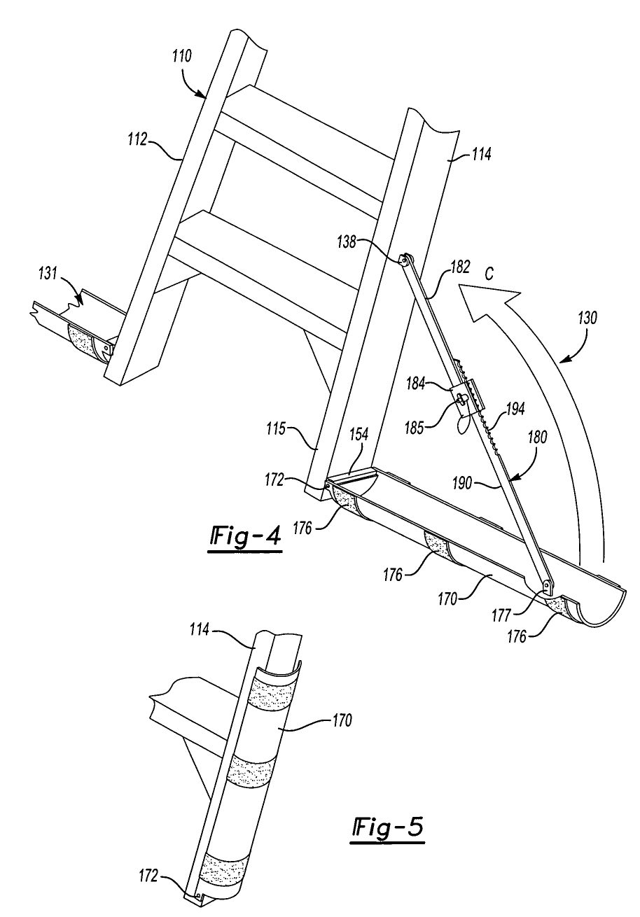

Referring now to FIGS. 4-5, an alternate embodiment ladder stabilization brace 130 is shown wherein stabilization brace 130 is integrally designed and fabricated as part of ladder 110. Ladder 110 can be either a step ladder, fixed ladder, or extension ladder having left and right stiles 112 and 114 wherein left stile 112 has a left stabilization brace 131 affixed thereto and right stile 114 has right stabilization brace 130 affixed thereto.

Stile 114 has a bottom end 114 to which a hinge 154 is affixed. Stile 114 also has an ear 138 affixed to an outer surface above hinge 154. A stabilization brace 170 has apertures 172 for registration with hinge 154 and to receive therethrough a hinge pin (not shown) thereby permitting stabilization brace 170 to pivot from a deployed position (as shown in FIG. 4) upwardly (Arrow ‘C’ in FIG. 4) to a stowed position (FIG. 5) against stile 114. Stabilization base 170 is formed as a semi-cylindrical form with non-slip strips 176 affixed to an outer surface thereof. Hinge 154 is positioned on stile 114 such that the weight of ladder 110 is supported by stabilization base 170 thereby ensuring the semi-cylindrical form of stabilization base 170 contacts the surface on which ladder 110 is desired to be supported.

Stabilization brace 130 also includes an adjustable center brace 180 identical to center brace 80 described above with a first brace arm pivotally attached to ear 138 on ladder stile 114 and a second brace arm pivotally attached to ear 177 in stabilization base 170. First brace arm 182 includes a sleeve 184 at an end opposite from ear 138 and second brace arm includes a plurality of recesses 194 at an end opposite from ear 177. A lock pin 185 engages recesses 194 to secure second brace arm 190 in sleeve 184 in a manner identical to center brace 80 above. Deployment and stowage of stabilization brace 170 are identical to those of stabilization brace 30 above.

The above description is considered that of the preferred embodiments only. Modifications of the invention will occur to those skilled in the art and to those who make or use the invention. Therefore, it is understood that the embodiments shown in the drawings and described above are merely for illustrative purposes and are not intended to limit the scope of the invention, which is defined by the following claims as interpreted according to the principles of patent law, including the doctrine of equivalents.

We claim:

1. A ladder stabilizing brace attachable to a ladder stile for laterally stabilizing the ladder from tipping, said stabilizing brace comprising:
a body channel affixable to a stile of a ladder;
a stabilizer base having a proximal end pivotally affixed to a bottom end of said body channel such that said stabilizer base pivots between a stowed position in vertical parallel registration with said body channel to a deployed position extending outwardly from said body channel; and
an adjustable center brace for locking said stabilizer base in said deployed position, said adjustable center brace extending between an upper end of said body channel and a distal end of said stabilizer base opposite from said proximal end.

2. The ladder stabilizing brace according to claim 1 wherein said stabilizer base has a semi-cylindrical form and further wherein an outer periphery of said semi-cylindrical form is oriented to bear on a surface supporting the ladder.

3. The ladder stabilizing brace according to claim 2 wherein said stabilizer base includes a non-slip covering affixed to said outer surface.

4. The ladder stabilizing brace according to claim 3 wherein said stabilizer base includes a plurality of non-slip covering strips affixed to said outer periphery and oriented substantially perpendicular to a longitudinal axis of said semi-cylindrical form.

5. The ladder stabilizing brace according to claim 1 wherein said body channel has a generally rectangular cross section including a front leg and a rear leg interconnected by an outer side web defining a recess for receiving the ladder stile therein.

6. The ladder stabilizing brace according to claim 5 wherein said rear leg further includes a lip opposite from said outer side web and extending toward said front leg for capturing a rear portion of the ladder stile therebehind.

7. The ladder stabilizing brace according to claim 5 further including at least one tightening knob having a threaded shaft threadingly received in said front leg and adjustable therein for capturing and bearing against the ladder stile.

8. The ladder stabilizing brace according to claim 7 wherein a first tightening knob is positioned proximate to a top of said body channel and a second tightening knob is positioned proximate to a bottom of said body channel.

9. The ladder stabilizing brace according to claim 1 wherein said adjustable center brace comprises a first brace arm pivotally affixed to one of said body channel and said stabilizer base and a second brace arm pivotally affixed to the other of said body channel and said stabilizer base, said first and said second brace arms adjustable one with respect to the other to vary a length of said adjustable center brace.

10. The ladder stabilizing brace according to claim 9 wherein:
said first brace arm is pivotal at a first end and has a sleeve affixed to an opposite end, said sleeve including a lateral aperture therethrough;
said second brace arm is pivotal at a second end and having a plurality of regularly spaced recesses along a first end, said first end of regularly spaced recesses slidably received in said sleeve; and
a locking pin received through said lateral aperture and engaging one of said plurality of recesses in said second brace arm to positionally affix said second brace arm with respect to said first brace arm thus locking said stabilizer base in said deployed position.

11. A ladder stabilizing brace attachable to a ladder stile for laterally stabilizing the ladder from tipping, said stabilizing brace comprising:
a stabilizer base having a first end defining at least one aperture therethrough for pivotally affixed to a bottom of a ladder stile such that said stabilizer base pivots between a stowed position in vertical parallel registration with the ladder stile to a deployed position extending outwardly from the ladder stile; and
an adjustable center brace for locking said stabilizer base in said deployed position, said adjustable center brace having a first end defining an aperture therethrough for pivotal attachment to the ladder stile and a second end pivotally affixed to a second end of said stabilizer base opposite from said first end.

12. The ladder stabilizing brace according to claim 11 wherein said stabilizer base has a semi-cylindrical form and further wherein an outer periphery of said semi-cylindrical form is oriented to bear on a surface supporting the ladder.

13. The ladder stabilizing brace according to claim 12 wherein said stabilizer base includes a non-slip covering affixed to said outer surface.

14. The ladder stabilizing brace according to claim 13 wherein said stabilizer base includes a plurality of non-slip covering strips affixed to said outer periphery and oriented substantially perpendicular to a longitudinal axis of said semi-cylindrical form.

15. The ladder stabilizing brace according to claim 14 wherein said non-slip covering strips are a resilient non-slip material.

16. The ladder stabilizing brace according to claim 15 wherein said non-slip covering strips are rubber.

17. The ladder stabilizing brace according to claim 11 wherein said adjustable center brace comprises a first brace arm defining an aperture at one end thereof for pivotally affixing to the ladder leg and a second brace arm pivotally affixed to said stabilizer base, said first and said second brace arms adjustable one with respect to the other to vary a length of said adjustable center brace.

18. The ladder stabilizing brace according to claim 9 wherein:
said first brace arm is pivotal at a first end and has a sleeve affixed to an opposite end, said sleeve including an aperture therethrough;
said second brace arm is pivotal at a second end and having a plurality of regularly spaced recesses along a first end, said first end of regularly spaced recesses slidably received in said sleeve; and
a locking pin received through said lateral aperture and engaging one of said plurality of recesses in said second brace arm to positionally affix said second brace arm with respect to said first brace arm thus locking said stabilizer base in said deployed position.

19. A ladder of the type having a pair of laterally spaced stiles supporting a plurality of vertically spaced rungs, each stile including at a bottom outer surface thereof a hinge, and further including an integral stabilizing brace pivotally affixed to each said hinge, wherein said stabilizing brace comprises:
a stabilizer base having a first end defining at least one aperture therethrough pivotally affixed to said hinge such that said stabilizer base pivots between a stowed position in vertical parallel registration with said ladder stile to a deployed position extending outwardly from said ladder stile; and
an adjustable center brace for locking said stabilizer base in said deployed position, said adjustable center brace having a first end pivotally attached to said ladder stile and a second end pivotally affixed to a second end of said stabilizer base opposite from said first end.

20. The ladder stabilizing brace according to claim 19 wherein said stabilizer base has a semi-cylindrical form and further wherein an outer periphery of said semi-cylindrical form is oriented to bear on a surface supporting the ladder, said outer surface including a non-slip covering affixed to said outer surface.
